(19) United States
(12) Patent Application Publication
(10) Pub. No.: US 2018/0354238 A1
(43) Pub. Date: Dec. 13, 2018

(54) MULTILAYER STRUCTURE COMPRISING A LAYER CONTAINING A FLUOROPOLYMER AND ACRYLIC COPOLYMER - ASSOCIATED PRODUCTION METHOD AND TUBE

(71) Applicant: Arkema France, Colombes (FR)

(72) Inventors: Florent ABRGALL, Bernay (FR); Samuel DEVISME, Rouen (FR); Thomas LABOUR, Aviron (FR); Jérôme RONDIN, Courbepine (FR)

(73) Assignee: Arkema France, Colombes (FR)

(21) Appl. No.: 15/781,204

(22) PCT Filed: Dec. 6, 2016
(86) PCT No.: PCT/FR2016/053232

§ 371 Date: Jun. 4, 2018

(30) Foreign Application Priority Data
Dec. 8, 2015 (FR) 1561980

(51) Int. Cl. B32B 27/08; B32B 27/30; B32B 27/32; B32B 7/12; B32B 7/10; B32B 1/08

(52) U.S. Cl. CPC B32B 27/08; B32B 27/308; B32B 27/32; B32B 27/304; B32B 2597/00; B32B 7/10; B32B 1/08; B32B 2250/246; B32B 2270/00; B32B 7/12

(57) ABSTRACT

“The present invention concerns a multilayer structure comprising, in the following order: optionally a layer A, comprising at least one fluoropolymer, a layer B comprising at least one fluoropolymer and one acrylic copolymer comprising monomers having a plurality of functional groups X, a layer C comprising of at least one first olefinic polymer comprising monomers having a plurality of functional groups Y capable of interacting with the functional groups X, optionally, an intermediate layer D comprising at least one second olefinic polymer comprising monomers having a plurality of functional groups Z capable of interacting with said functional groups Y, said second olefinic polymer being different to that/those comprised in said layer C; and a layer E comprising at least one third olefinic polymer that is incompatible with said fluoropolymer of said layer A and/or said layer B.

### FIELD OF THE INVENTION

The present invention relates to a multilayer structure capable of being used in particular in the transport of water.

### TECHNICAL BACKGROUND

Fluoropolymers, in particular the polymers obtained from vinylidene fluoride, have a great chemical inertness, which makes them in particular suitable for transporting numerous chemicals. Their resistance to chlorinated agents (chlorine dioxide, chloramines, sodium hypochlorite, etc.) makes them excellent candidates for applications in the transport of water, in particular hot water, especially in a hospital and sanitary environment, where aggressive treatments based on chlorinated agents are commonly used.

The drinking water conduits or lines must meet very strict criteria. The line must not lose its mechanical properties owing to the treated water that it contains; it must in particular be resistant to aging, not be perforated or break and be flexible to facilitate the installation thereof. It must furthermore preserve the quality of the water transported: the structure of the line should only emit a small amount of given chemical compounds into the water transported and/or should prevent the accumulation of a biofilm on the inner surface of the line. The line should also be easy to manufacture, for example by coextrusion.

Polyolefins and in particular polyethylenes have mechanical properties that make them suitable to be used in the form of a tube for a line. Nevertheless, the limited chemical resistance of these polymers makes them sensitive to the chlorinated agents used for treating the water, more particularly under high temperature conditions (above 70° C.).

An inner fluoropolymer layer combined with a polyolefin layer may thus protect the latter from the action of these aggressive chemicals contained in the water. However, due to their different chemical nature, these polymers are incompatible; it is therefore difficult to make the fluoropolymers adhere to the polyolefins.

Document DE 202011103017 U1 describes lines for drinking water that comprise a tube made of PVDF (polyvinylidene fluoride). This tube is covered with an aluminum foil and attached to the latter by means of a binder; the aluminum foil is itself covered with a layer of polyethylene. The aluminum foil gives the line a low permeation to gases and limits the migration of the chemical constituents of the polyethylene toward the water. The presence of the aluminum foil makes the line expensive and difficult to manufacture.

Document FR 2 892 171 describes a tube that can be used as a line for transporting water. This tube comprises a multilayer structure that comprises a layer C2 containing a functionalized fluoropolymer bonded to a layer C3 or C4 containing a polyolefin. It turns out that this type of multilayer structure withstands aging poorly when it is in contact with hot water.

There is still a need to formulate new binders that make it possible to attach a fluoropolymer to another polymer that is incompatible therewith. There is very particularly a need to develop new binders that make it possible to manufacture multilayer structures suitable especially for transporting drinking water, in particular hot drinking water.

One problem that the invention intends to solve is to provide a multilayer structure that has a good adhesion between a layer comprising a fluoropolymer and a layer of polymer incompatible with said fluoropolymer.

Another objective of the present invention is to provide a multilayer structure having a satisfactory degree of adhesion, for example substantially greater than or equal to 30 N/cm between the layer comprising a fluoropolymer and the incompatible polymer layer, this adhesion being measured by longitudinal peeling, i.e. longitudinal cutting of a tube and measurement of the adhesion by the “imposed 90° peel” method at a temperature of 23° C. and a pull rate of 50 mm/min, the lever arm composed of the layer(s) containing the fluoropolymer having a total thickness of between 200 and 400 μm.

Another objective of the present invention is to provide a multilayer structure that can withstand aging (especially over at least 2000 hours) in water at a temperature equal to or above 80° C., in particular equal to 95° C., this water possibly containing chlorinated agents used for treating the water.

### SUMMARY OF THE INVENTION

In order to achieve one of the aforementioned objectives, the present invention relates to a multilayer structure comprising, in order:
optionally a layer A comprising at least one fluoropolymer,
a layer B comprising at least one fluoropolymer and one acrylic copolymer comprising monomers having a plurality of functional groups X,
a layer C comprising, and preferably consisting of, at least one first olefinic polymer comprising monomers having a plurality of functional groups Y capable of interacting with the functional groups X,
optionally, an intermediate layer D comprising at least one second olefinic polymer comprising monomers having a plurality of functional groups Z capable of interacting with said functional groups Y, said second olefinic polymer being different from that/those included in said layer C,
a layer E comprising at least one polymer, and in particular an olefinic polymer incompatible with said fluoropolymer of said layer A and/or of said layer B.

The applicant has indeed demonstrated that it was possible to obtain a better adhesion between a fluoropolymer and a polymer incompatible with said fluoropolymer, these polymers being incorporated into two different non-adjacent layers, by means of an assembly formed from a layer comprising a mixture of a fluoropolymer with an acrylic copolymer comprising functional groups as mentioned above, said layer being attached to at least one intermediate layer containing at least one functionalized olefinic polymer. A multilayer structure that is simple to manufacture and inexpensive is thus obtained.

The various layers forming the structure may also comprise additives, especially rheological additives, impact modifiers, pigments, and also any other additives known to a person skilled in the art.

In the case of use of a multilayer structure of the invention in contact with drinking water, the multilayer structure according to the invention preferably comprises a layer A in direct contact with the drinking water. The presence of this layer A ensures a better chemical resistance to the water treatment agents and a better resistance to the formation of biofilm at the surface of the material in direct contact with the drinking water.

The present invention also relates to a tube for transporting fluids, especially liquids such as water or liquids for food use, said tube being more particularly suitable for transporting drinking water, especially hot drinking water.

### DESCRIPTION OF EMBODIMENTS OF THE INVENTION

The invention is now described in greater detail and in a nonlimiting manner in the description which follows.

The present invention relates to a multilayer structure comprising, in order:
optionally a layer A comprising at least one fluoropolymer,
a layer B comprising at least one fluoropolymer and one acrylic copolymer comprising monomers having a plurality of functional groups X,
a layer C comprising, and preferably consisting of, at least one first olefinic polymer comprising monomers having a plurality of functional groups Y capable of interacting with the functional groups X,
optionally, an intermediate layer D comprising at least one second olefinic polymer comprising monomers having a plurality of functional groups Z capable of interacting with said functional groups Y, said second olefinic polymer being different from that/those included in said layer C,
a layer E comprising at least one polymer, and in particular an olefinic polymer incompatible with said fluoropolymer of said layer A and/or of said layer B.

Characteristically, the monomers bearing functional groups Y are unsaturated epoxides or vinyl esters of saturated carboxylic acids.

These layers are described in detail hereinbelow.

Layer B

The layer B comprises at least one fluoropolymer and one acrylic copolymer comprising monomers having a plurality of functional groups X.

According to one embodiment, the functional groups X are carboxyl groups.

According to one embodiment, the functional groups X are carboxylic acid anhydride groups.

According to one embodiment, the functional groups X are mixtures of carboxyl and carboxylic acid anhydride groups.

According to one embodiment, the acrylic copolymer is a copolymer of methyl methacrylate and glutaric anhydride or a copolymer of methyl methacrylate and methacrylic acid or a mixture of these two copolymers.

Advantageously, the acrylic copolymer of said layer B comprises, by weight, from 1% to 50%, preferentially between 1% and 25%, limits included, of monomers bearing a function X described above.

Preferably, said layer B is free of alpha-olefinic polymer comprising at least one functional group chosen from carboxyl, acid anhydride, hydroxyl and epoxy groups.

The fluoropolymer of layer A and that of layer B are not limiting according to the invention. They may be identical or different in the two layers. The layers may also comprise a mixture of at least two fluoropolymers, this mixture being identical or different in the layers A and B.

Thus, the fluoropolymer(s) of the layers A and B is/are chosen from homopolymers of vinylidene fluoride (PVDF) and copolymers of vinylidene fluoride and of at least one other comonomer. According to one embodiment, the comonomer of the VDF is chosen from vinyl fluoride, trifluoroethylene (VF3), chlorotrifluoroethylene (CTFE), 1,2-difluoroethylene, tetrafluoroethylene (TFE), hexafluoropropylene (HFP), perfluoro(alkyl vinyl ethers) such as perfluoro(methyl vinyl ether) (PMVE), perfluoro(ethyl vinyl ether) (PEVE), perfluoro(propyl vinyl ether) (PPVE), perfluoro(1,3-dioxozole); perfluoro(2,2-dimethyl-1,3-dioxole) (PDD), the product of formula CF₂═CFOCF₂CF(CF₃)OCF₂CF₂X in which X is SO₂F, CO₂H, CH₂OH; CH₂OCN or CH₂OPO₃H, the product of formula CF₂═CFOCF₂CF₂SO₂F; the product of formula F(CF₂)nCH₂OCF═CF₂ in which n is 1, 2, 3, 4 or 5, the product of formula R₁CH₂OCF═CF₂ in which Ri is hydrogen or F(CF₂)_{z} and z is equal to 1, 2, 3 or 4; the product of formula R₃OCF═CH₂ in which R₃ is F(CF₂)_{z} and z is equal to 1, 2, 3 or 4 or else perfluorobutylethylene (PFBE), fluoroethylene-propylene (FEP), 3,3,3-trifluoropropene, 2-trifluoromethyl-3,3,3-trifluoro-l-propene, 2,3,3,3-tetrafluoropropene or HFO-1234yf, E-1,3,3,3-tetrafluoropropene or HFO-1234zeE, Z-1,3,3,3-tetrafluoropropene or HFO-1234zeZ, 1,1,2,3-tetrafluoropropene or HFO-1234yc, 1,2,3,3 -tetrafluoropropene or HFO-1234ye, 1,1,3,3-tetrafluoropropene or HFO-1234zc, chlorotetrafluoropropene or HCFO-1224, chlorotrifluoropropenes (especially 2-chloro-3,3,3-trifluoropropene), 1-chloro-2-fluoroethylene, trifluoropropenes (especially 3,3,3-trifluoropropene), pentafluoropropenes (especially 1,1,3,3,3 -pentafluoropropene or 1,2,3,3,3 -pentafluoropropene), 1-chloro-2,2-difluoroethylene, 1-bromo-2,2-difluoroethylene, and bromotrifluoroethylene. The copolymer may also comprise non-fluorinated monomers such as ethylene.

According to one embodiment of a VDF (vinylidene fluoride) copolymer that can be used for the layer A and for the layer B, the comonomer is hexafluoropropylene (HFP). According to one embodiment that may be combined with any one of the aforementioned embodiments, the fluoropolymer of the layer A is a vinylidene fluoride homopolymer, the fluoropolymer of the layer B is also a vinylidene fluoride homopolymer but different from that of the layer A.

Layer C

The layer C comprises, and preferably consists of, at least one first olefinic polymer comprising monomers having functional groups Y capable of interacting with the functional groups X.

The monomers bearing functional groups Y are chosen from:
unsaturated epoxides, especially aliphatic glycidyl esters and ethers, such as allyl glycidyl ether, vinyl glycidyl ether, glycidyl maleate and itaconate, glycidyl methacrylate and acrylate, and also alicyclic glycidyl esters and ethers; and
vinyl esters of saturated carboxylic acids, especially vinyl acetate or vinyl propionate.

According to one particular embodiment of the layer C which may be combined with any one of the embodiments of the other layers, the first olefinic polymer is a copolymer of ethylene and of at least one unsaturated polar monomer bearing functions Y from the preceding list which contains, by weight, at least 50%, advantageously more than 60% and preferably at least 65% of ethylene.

According to one particular embodiment of the layer C which may be combined with any one of the embodiments of the other layers, the first olefinic polymer is a terpolymer of ethylene, of at least one unsaturated polar monomer bearing functions Y from the preceding list and of C₁-C₈ alkyl (meth)acrylates, in particular methyl, propyl, butyl, 2-ethylhexyl, isobutyl or cyclohexyl (meth)acrylate. This terpolymer contains, by weight, at least 50%, advantageously more than 60% and preferably at least 65% of ethylene.

This first olefinic polymer may comprise, by weight, from 50% to 99.9% of ethylene, preferably from 60% to 99.9%, more preferentially still from 65% to 99.9% and from 0.1% to 50%, preferably from 0.1% to 40%, more preferentially still from 0.1% to 35% of at least one unsaturated polar monomer bearing functions Y from the preceding list. The limits of the aforementioned intervals correspond to values by weight that the olefinic polymer of the invention may contain.

Layer D

According to one embodiment which may be combined with the other aforementioned embodiments with reference to the layers A, B, C and E, the structure according to the invention comprises an intermediate layer D.

The intermediate layer D comprises at least one second olefinic polymer comprising monomers having functional groups Z capable of interacting with said functional groups Y, said second olefinic polymer being different from that/those included in said layer C.

The functional groups Z are chosen from unsaturated carboxylic acids, unsaturated dicarboxylic acids having 4 to 10 carbon atoms and anhydride derivatives thereof

Said second olefinic polymer is chosen from the polymers obtained by grafting at least one unsaturated polar monomer having a functional group Z to at least one propylene homopolymer or one copolymer of propylene and of an unsaturated polar monomer chosen from C₁-C₈ alkyl esters or glycidyl esters of unsaturated carboxylic acids, or salts of unsaturated carboxylic acids or a mixture thereof.

Advantageously, the polymer comprises, by weight, an amount of said grafting monomer equal to or less than 5%.

The second olefinic polymer is preferably, independently of the other constituents of the other layers, a maleic anhydride-grafted polypropylene.

Layer E

According to one particular embodiment, which may be combined with any one of the aforementioned embodiments, said multilayer structure optionally comprises the layer A, the layers B and C and a layer E. The layer E comprises at least one polymer, and in particular a third olefinic polymer incompatible with said fluoropolymer of said layer A and/or of said layer B.

When said multilayer structure comprises the layer A and the layers B, C and E, said polymer incompatible with the layer E is chosen from ethylene homopolymers, copolymers of ethylene and of at least one other monomer chosen from alpha-olefins, alkyl acrylates, vinyl acetates and the mixtures of these polymers.

The incompatible polymer contained in the layer E denotes a polymer predominantly comprising ethylene and/or propylene monomers. It may be a polyethylene, homopolymer or copolymer, the comonomer being chosen from alpha-olefins (especially propylene, butene, hexene, octene), alkyl acrylates and vinyl acetates. It may also be a propylene, homopolymer or copolymer, the comonomer being chosen from alpha-olefins (especially ethylene, butene, hexene, octene). The incompatible polymer may also be a mixture of these various polymers.

The polyethylene may especially be high-density polyethylene (HDPE), low-density polyethylene (LDPE), linear low-density polyethylene (LLDPE), very low-density polyethylene (VLDPE). The polyethylene may be obtained using a Ziegler-Natta, Phillips or metallocene-type catalyst or else using the high-pressure process. It may also be a crosslinked polyethylene (PEX). The PEX has, compared to a non-crosslinked PE, better mechanical properties (especially as regards the crack resistance) and a better chemical resistance. The polyethylene may be crosslinked using a radical initiator of peroxide type (PEX-a). The crosslinked polyethylene may also be, for example, a polyethylene comprising hydrolyzable silane groups (PEX-b) enabling the formation of Si—O—Si bonds that link the polyethylene chains together. The polyethylene may also be crosslinked using radiation, for example gamma radiation (PEX-c).

When the multilayer structure according to the invention comprises a layer D, said polymer of said layer E is preferably chosen from propylene homopolymers, copolymers of propylene and of an alpha-olefin and the mixtures of these polymers.

The polypropylene is preferably an isotactic or syndiotactic polypropylene.

The process for manufacturing the multilayer structure according to the invention is not limiting. It may be obtained, for example, by coextrusion.

The multilayer structure according to the invention may make it possible to form tubes, that can be used as a line for transporting fluids, especially liquids, in particular for transporting water, advantageously drinking water and hot drinking water in particular. The thickness of the multilayer structure according to the invention varies from 0.5 to 10 mm, preferably from 0.8 to 5 mm and more preferably still from 1 to 3 mm, limits included.

Advantageously, when it is a tube, said layer E is the outer layer of said tube. It provides the mechanical strength of the tube.

Advantageously, the tube may comprise an inner layer A which prevents the formation of biofilm on the inner surface of the tube. The combination of the layers B and C makes it possible to ensure a high adhesion between the various layers of the structure, even in the case of hot water circulation.

The tube may comprise the layers B, C and E or the layers A, B, C and E or the layers B, C, D and E or the layers A, B, C, D and E. Preferably, it comprises the layers A, B, C and E. When it is present, the layer D is located between the layer C and the layer E. The present invention also relates to the use of a tube comprising the layers B, C and E for transporting fluids, especially liquids, in particular for transporting water, for example drinking water and domestic supply water, and especially hot water.

The present invention also relates to the use of a tube comprising the aforementioned layers B, C, D and E for transporting drinking water.

The present invention also relates to the use of a tube comprising the aforementioned layers B, C, D and E for transporting drinking water and especially hot drinking water.

The present invention also relates to the use of a tube comprising the aforementioned layers A, B, C, D and E for transporting drinking water and especially hot drinking water.

The layers A and B may contain one or more identical fluoropolymers or different fluoropolymers.

Definitions:

The term “interact” with reference to the functional groups X, Y and Z encompasses any type of interaction capable of giving rise to the bonding of the layers; it may be a chemical reaction between the functional groups of the layers in contact, diffusion of chains at the interface, the macromolecules of one layer being embedded in those of the adjacent layer, intermolecular bonds of van der Waals type or hydrogen bonds, or a mixture of these interactions.

The term “acrylic copolymer comprising monomers having a plurality of functional groups X”, contained in the layer B, denotes a copolymer comprising:
units of the type:

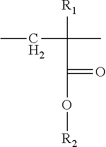

in which R₁ and R₂ represent a hydrogen atom or a linear or branched alkyl having from 1 to 20 carbon atoms; it being possible for R₁ and R₂ to be identical or different;
and units of the type:

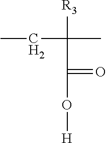

in which R₃ is a hydrogen atom or a linear or branched alkyl containing one to twenty carbon atoms.

The latter unit may be in its acid form, but also in its anhydride derivatives or a mixture of these. When it is in anhydride form, this unit may be represented by the formula:

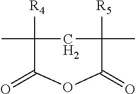

in which R₄ and R₅ represent a hydrogen atom or a linear or branched alkyl having from 1 to 20 carbon atoms; it being possible for R₄ and R₅ to be identical or different. According to one embodiment, the acrylic copolymer comprises up to 50% by weight of the unit in acid form or its anhydride derivative or a mixture of the two. Advantageously, the acrylic copolymer comprises up to 25% by weight of the unit in acid form or its anhydride derivative or a mixture of these.

According to another embodiment, R₁ and R₂ represent the methyl radical. In this case, the binder is based on PMMA.

According to another embodiment, R₃ represents the hydrogen or methyl radical in the case where the unit that bears it is in acid form, and R₄ and R₅ represent the hydrogen or methyl radical in the case where the unit is in anhydride form.

The expression “drinking water” denotes water that has undergone a potabilization treatment and that therefore contains water treatment chemicals such as those mentioned with reference to the prior art.

The expression “suitable for transporting drinking water” means that the polymer in question contains components that all appear on a list of components considered to be suitable for transporting drinking water chosen from the following documents: “WRAS certificate according to Standard B S6920” for the United Kingdom, “KTW certificate to Regulations KTW 1.3.13” for Germany, “KIWA certificate according to Regulations BRL 2013” for the Netherlands, the ACS certificate according to the circular published by the French Department of Health: DSG/VS4 no. 2000/232 dated 27 Apr. 2000 and the Italian decree D.M. no. 174 (ministerial decree No. 174 dated Jun. 4, 2007).

### EXAMPLES

The following examples illustrate the invention without limiting it.

Materials used:
PVDF-1: PVDF homopolymer with a melt flow index (MFI)=20 g/10 min (230° C., 3.8 kg) and a melting point of around 170° C.
PVDF-2: PVDF homopolymer with a melt flow index (MFI)=2 g/10 min (230° C., 5 kg) and a melting point of around 170° C.
PVDF-3: Maleic anhydride-grafted PVDF homopolymer with a melt flow index (MFI)=15 g/10 min (230° C., 3.8 kg) and a melting point of around 170° C. Used by way of comparison with the PVDF-2 +acrylic copolymers mixtures described below.
CA-1: Copolymer of methyl methacrylate and of 1,3-dimethylglutaric anhydride and with a melt flow index (MFI)=3.5 g/10 min (230° C., 3.8 kg)
CA-2: Copolymer of methyl methacrylate and of methacrylic acid with a melt flow index (MFI)=2 g/10 min (230° C., 3.8 kg)
CA-3: Copolymer of methyl methacrylate and of methacrylic acid with a melt flow index (MFI)=3.5 g/10 min (230° C., 3.8 kg)
POF-1: Copolymer of ethylene and of glycidyl methacrylate with a melt flow index (MFI)=5 g/10 min (190° C., 2.16 kg), a density of 0.94 g/cm³ at 23° C. and a melting point of 105° C.
POF-2: Maleic anhydride-grafted polypropylene with a melt flow index (MFI)=7 g/10 min (230° C., 2.16 kg)
PE: Polyethylene with a melt flow index (MFI)=0.2 g/10 min (190° C., 2.16 kg) and a density of 0.938 g/cm³ at 23° C.
PP: Polypropylene with a melt flow index (MFI)=0.25 g/10 min (230° C., 2.16 kg) and a density of 0.905 g/cm³ at 23° C.

Multilayer Structures Prepared:

Multilayer Tube S1

The multilayer tube S1 is formed of four successive layers (from the inside to the outside):

Layer A: PVDF-1

Layer B: PVDF-2+acrylic copolymer chosen from CA-1, CA-2, CA-3 or PVDF-3 (comparative example)

Layer C: POF-1

Layer E: PE

Multilayer Tube S2

The multilayer tube S2 is formed of five successive layers (from the inside to the outside):

Layer A: PVDF-1

Layer B: PVDF-2+acrylic copolymer chosen from CA-1, CA-2, CA-3 or PVDF-3 (comparative example)

Layer C: POF-1

Layer D: POF-2

Layer E: PP

Multilayer Tube S3

The multilayer tube S3 is formed of three successive layers (from the inside to the outside):

Layer B: PVDF-2+acrylic copolymer chosen from CA-1, CA-2, CA-3 or PVDF-3 (comparative example)

Layer C: POF-1

Layer E: PE

The mixtures of PVDF-2 and of acrylic copolymer used in the layer B of these structures S1, S2 and S3 are prepared beforehand in a co-rotating twin-screw extruder under conditions that comply with the rules of the art, at a setpoint temperature of 220° C.

Measurement of the Adhesion:

The inter-layer adhesion is measured by a peel test according to the “imposed 90° peel” method at a temperature of 23° C. and a pull rate of 50 mm/min. The lever arm is composed of the layers A and B and has a total thickness of between 200 and 400 μm. The interface under strain is thus the one between the layers B and C. The adhesion measurement is carried out 24 h after producing the multilayer tube. Adhesion measurements following the same protocol are also carried out after the multilayer tube has been submerged for 1000 h and 2000 h in water at 95° C. (pressure=1 bar).

### Example 1

A multilayer tube of structure S1 is produced by coextrusion using a device manufactured by the company McNeil Akron Repiquet. The coextrusion of these products is carried out at a temperature of 245° C. The tube has an external diameter of 20 mm and a total thickness of 2 mm. The thickness distribution within the structure is the following:
Layer A: 200 ∥m
Layer B: 100 μm
Layer C: 100 μm
Layer E: 1600 μm

The nature and the concentration of the acrylic copolymer within the layer B is variable. By way of comparison, the polymer PVDF-3 is used for the layer B.

Table I below presents the various mixtures used in the layer B and the results of the adhesion tests. The number indicated in the bottom of each box corresponds to the standard deviation of the adhesion value indicated above.

TABLE I

| | Mass fraction | | Adhesion at | Adhesion at |
|---|---|---|---|---|
| | of acrylic | Adhesion | t0 + 1000 h | t0 + 2000 h |
| | copolymer in | at t0 + 24 h | hot water | hot water |
| layer B | the layer B (%) | (N/cm) | (N/cm) | (N/cm) |
| PVDF-3 | — | 34.0 | 3.9 | 3.4 |
| (control) | | 1.8 | 1.3 | 0.6 |
| PVDF-2 + | 10 | 52.9 | 44.5 | 47.2 |
| CA-1 | | 3.8 | 3.8 | 2.7 |
| PVDF-2 + | 6 | N.P. | 49.8 | 49.5 |
| CA-2 | | — | 3.1 | 3 |
| PVDF-2 + | 3 | N.P. | 40.3 | 40.2 |
| CA-3 | | — | 2.2 | 5.2 |

The letters N.P. indicated in Table II indicate that the initiation cannot be propagated which means that the adhesion between the layers B and C is so high that, by exerting a force on the lever arm, its rupture stress is exceeded and the sample breaks without being able to separate the aforementioned two layers.

It is observed that adhesions of greater than 40 N/cm are achieved with each of the 3 acrylic copolymers tested and are maintained after aging. The use of a binder according to the invention comprising an acrylic copolymer bearing a functional group X therefore makes it possible to obtain an improved adhesion relative to the functionalized PVDF, PVDF-3. The use of the latter clearly induces a gradual loss of adhesion at the interface between the layers B and C during exposure to water at 95° C., followed by cohesive failure at the interface between the layers. The multilayer tube according to the invention thus has a better resistance to aging, especially in hot water. The adhesion in hot water after 1000 h is substantially the same as that obtained after 2000 h and remains above the threshold of 30 N/cm.

### Example 2

A multilayer tube of structure S1 is produced by coextrusion using a device manufactured by the company McNeil Akron Repiquet. The coextrusion of these products is carried out at a temperature of 245° C. The tube has an external diameter of 20 mm and a total thickness of 2 mm. The thickness of the layer B is variable within the structure, which leads to the following thickness distribution:
Layer A: x μm
Layer B: 100 μm
Layer C: 100 μm
Layer E: 1800−x μm

The nature and the concentration of the acrylic copolymer within the layer B is variable. By way of comparison, the polymer PVDF-3 is used in the layer B. The adhesion measurements at the interface between the layers B and C are presented in Table II.

TABLE II

| | Mass | | | Adhesion | Adhesion |
|---|---|---|---|---|---|
| | fraction | Thickness | Adhesion | at t0 + | at t0 + |
| | of acrylic | of the | at t0 + | 1000 h | 2000 h |
| | copolymer in | layer A | 24 h | hot water | hot water |
| layer B | the layer B | (x) (μm) | (N/cm) | (N/cm) | (N/cm) |
| PVDF-3 | — | 200 | 34.0 | 3.9 | 3.4 |
| (control) | | | 1.8 | 1.3 | 0.6 |
| PVDF-2 + | 10 | 100 | 41.5 | 37.7 | 38 |
| CA-1 | | | 3.3 | 2.3 | 7.2 |
| | | 200 | 52.9 | 44.5 | 47.2 |
| | | | 3.8 | 3.8 | 2.7 |
| | | 300 | 43.6 | 56.4 | 56.9 |
| | | | 1.7 | 6.2 | 2.9 |
| PVDF-2 + | 6 | 100 | N.P. | 30.6 | 23.6 |
| CA-2 | | | — | 1.1 | 4.8 |
| | | 200 | N.P. | 49.8 | 49.5 |
| | | | — | 3.1 | 3 |
| | | 300 | N.P. | 49.1 | 52.3 |
| | | | — | 1.9 | 1 |

It is observed that an increase in the thickness of the layer A, therefore in the thickness of the internal lever arm, gives rise to an increase in the result measured during the adhesion test. This illustrates the mechanical contribution in the deformation of the lever arm in this measurement. A comparison of the degree of adhesion obtained in 2 different structures can therefore only be carried out with constant lever arm thickness, composition of this lever arm as close as possible and identical temperature.

Furthermore, this example also shows that, in the case of an inner layer of PVDF-1=100 μm, a gradual drop in adhesion is observed with the “PVDF-2+CA-2” binder whereas the degree of adhesion measured under the same conditions for the “PVDF-2+CA-1” binder remains stable. The presence of anhydride groups therefore enables a better maintenance of the adhesion in this structure.

### Example 3

A multilayer tube of structure S2 is produced by coextrusion using a device manufactured by the company McNeil Akron Repiquet. The coextrusion of these products is carried out at a temperature of 245° C. The tube has an external diameter of 32 mm and a total thickness of 3 mm. The thickness distribution within the structure is the following:
Layer A: 300 μm
Layer B: 100 μm
Layer C: 500 μm
Layer D: 500 μm
Layer E: 1600 μm

The nature and the concentration of the acrylic copolymer within the layer B is variable. By way of comparison, the polymer PVDF-3 is used in the layer B.

Table III below presents the various mixtures used in the layer B and the adhesions generated at the interface between the layers B and C.

Adhesions of greater than 40 N/cm are achieved with each of the 3 acrylic copolymers tested and are maintained after aging. This is not the case when a functionalized PVDF, PVDF-3, is used as binder, with which a significant loss of adhesion is observed after 1000 h of aging in water at 95° C.

TABLE III

| | Mass fraction | | |
|---|---|---|---|
| | of acrylic | | Adhesion at |
| | copolymer in | Adhesion at | t0 + 1000 h |
| | the layer B | t0 + 24 h | hot water |
| layer B | — | (N/cm) | (N/cm) |
| PVDF-3 | 100 | 47.2 | 12.3 |
| (control) | | 4.7 | 2.3 |
| CA 1 | 10 | 61.4 | 44.5 |
| | | 9.2 | 3.5 |
| CA-2 | 10 | 54.9 | 57.9 |
| | | 5.6 | 4.6 |
| CA-3 | 10 | 135.2 | 85.5 |
| | | 6.8 | 6.1 |

### Example 4

Multilayer tubes of structure S1 and S3 are produced by coextrusion using a device manufactured by the company McNeil Akron Repiquet. The coextrusion of these products is carried out at a temperature of 245° C. The tube has an external diameter of 20 mm and a total thickness of 2 mm. The thickness distribution within the structures is the following:
S1:
Layer A: 200 μm
Layer B: 100 μm
Layer C: 100 μm

Layer E: 1600 μm

S3:
Layer B: 300 μm
Layer C: 100 μm
Layer E: 1600 μm

The total thickness of the layers A and B containing fluoropolymers remains identical in the tubes of the 2 structures. The nature and the concentration of the acrylic copolymer within the layer B is variable.

TABLE IV

| | Mass | | | | |
|---|---|---|---|---|---|
| | fraction | | | Adhesion | Adhesion |
| | of acrylic | | Adhesion | at t0 + | at t0 + |
| | copolymer in | | at t0 + | 1000 h | 2000 h |
| | the layer B | Structure | 24 h | hot water | hot water |
| layer B | (%) | of the tube | (N/cm) | (N/cm) | (N/cm) |
| PVDF-2 + | 10 | S1 | 52.9 | 44.5 | 47.2 |
| CA-1 | | | 3.8 | 3.8 | 2.7 |
| | | S3 | 44.4 | 47.9 | 45.3 |
| | | | 1.2 | 3.1 | 2.9 |
| PVDF-2 + | 6 | S1 | N.P. | 49.8 | 49.5 |
| CA-2 | | | — | 3.1 | 3 |
| | | S3 | N.P. | 51.5 | 47.3 |
| | | | — | 4.2 | 1.9 |

The data presented in Table IV show that the interfacial adhesions, even after aging, to not vary according to the presence of an inner layer without acrylic copolymer. The choice of the use of this optional additional layer then depends on other desired properties such as the permeability, the chemical sensitivity or the surface appearance of the tube.

1. A multilayer structure comprising, in order:
a layer B comprising at least one fluoropolymer and one acrylic copolymer comprising monomers having functional groups X,
a layer C consisting of at least one first olefinic polymer comprising monomers having functional groups Y capable of interacting with the functional groups X, the monomers bearing functional groups Y being unsaturated epoxides or vinyl esters of saturated carboxylic acids,
and
a layer E comprising at least one olefinic polymer, incompatible with said fluoropolymer of said layer B.

2. The multilayer structure as claimed in claim 1, further comprising a layer A comprising at least one fluoropolymer, said layer A juxtaposing the layer B.

3. The multilayer structure as claimed in claim 1, further comprising, between the layer C and the layer E, an intermediate layer D comprising at least one second olefinic polymer comprising monomers having functional groups Z capable of interacting with said functional groups Y, said second olefinic polymer being different from that/those included in said layer C.

4. The multilayer structure as claimed in claim 1, wherein said functional groups X are chosen from carboxyl groups, carboxylic acid anhydrides, and mixtures of these groups.

5. The multilayer structure as claimed in claim 1, wherein:
said unsaturated epoxides are selected from the group consisting of aliphatic glycidyl esters, aliphatic glycidyl ethers, allyl glycidyl ether, vinyl glycidyl ether, glycidyl maleate, itaconate, glycidyl methacrylate and acrylate, alicyclic glycidyl esters, and alicyclic glycidyl ethers; and in that
said vinyl esters of saturated carboxylic acids are vinyl acetate or vinyl propionate.

6. The multilayer structure as claimed in claim 3, wherein said functional groups Z are chosen from unsaturated carboxylic acids, unsaturated dicarboxylic acids having 4 to 10 carbon atoms and anhydride derivatives thereof.

7. The multilayer structure as claimed in claim 1, wherein said acrylic copolymer of said layer B contains alkyl (meth)acrylate units.

8. The multilayer structure as claimed in, wherein, said acrylic copolymer of said layer B comprises, by weight, from 1% to 50% of monomers bearing functions X.

9. The multilayer structure as claimed in claim 1, wherein said layer B is free of alpha-olefinic polymer comprising at least one functional group chosen from a carboxyl group, an acid anhydride group, a hydroxyl group and an epoxy group.

10. The multilayer structure as claimed in claim 1, wherein said first olefinic polymer of said layer C comprises, by weight, at least 50% of ethylene comonomer in addition to the unsaturated polar comonomer having functional groups Y.

11. The multilayer structure as claimed in claim 1, wherein said first olefinic polymer of said layer C is a terpolymer of ethylene, of an unsaturated polar comonomer having functional groups Y, and of a C₁-C₈ alkyl (meth)acrylate.

12. The multilayer structure as claimed in claim 1, wherein said second olefinic polymer of said layer D is obtained by grafting at least one unsaturated polar monomer having a functional group Z to at least one propylene homopolymer or one copolymer of propylene and of an unsaturated polar monomer chosen from C₁-C₈ alkyl esters or C₁-C₈ alkyl glycidyl esters of unsaturated carboxylic acids, or salts of unsaturated carboxylic acids or a mixture thereof.

13. The multilayer structure as claimed in claim 1, wherein, when said multilayer structure optionally comprises the layer A and the layers B, C and E, said polymer incompatible with the layer E, said layer A being chosen from ethylene homopolymers, copolymers of ethylene and of at least one other monomer chosen from alpha-olefins, alkyl acrylates, vinyl acetates and the mixtures of these polymers.

14. The multilayer structure as claimed in claim 3, wherein, when said multilayer structure comprises a layer D, said polymer incompatible with said layer E is chosen from propylene homopolymers, copolymers of propylene and of an alpha-olefin and the mixtures of these polymers.

15. A tube comprising said multilayer structure of claim 1, and in that said layer E is the outer layer of said tube.

16. The tube as claimed in claim 15, wherein said tube transports fluids.

17. The tube as claimed in claim 16, wherein said tube transports drinking water.

18. The multilayer structure as claimed in claim 11, wherein said first olefinic polymer of said layer C is a terpolymer of ethylene, of an unsaturated polar comonomer having functional groups Y, and of methyl, propyl, butyl, 2-ethylhexyl, isobutyl or cyclohexyl (meth)acrylate.

19. The tube as claimed in claim 17, wherein said tube transports hot drinking water.
